(19) United States
(12) Patent Application Publication
(10) Pub. No.: US 2012/0275605 A1
(43) Pub. Date: Nov. 1, 2012

(54) Audio Playback

(75) Inventor: Anthony Green, Penshaw (GB)

(73) Assignee: SOUND AFFINITY LIMITED, Tyne and Wear (GB)

(21) Appl. No.: 13/455,569

(22) Filed: Apr. 25, 2012

(30) Foreign Application Priority Data
Apr. 26, 2011 (GB) 1106998.6
Apr. 26, 2011 (GB) 1106999.4
Apr. 26, 2011 (GB) 1107002.6

(51) Int. Cl. H04R 5/00; G06F 17/00

(52) U.S. Cl. 381/17; 700/94

(57) ABSTRACT

A multifunctional device is disclosed capable of audio playback. The device includes a receiver (1301) for receiving audio data files and a storage device (1305) for storing received data files. A manually accessible physical play button (1303) is responsive to a request to sequentially play the audio data files contiguously in a temporal order. The data files may remain in storage until all of the available memory has been used, whereafter the audio data files are overwritten with new material on a first-in-first-out basis. The device is also capable of creating a soundscape to facilitate menu selection via a bowl-shaped user interface.

### CROSS REFERENCE TO RELATED APPLICATIONS

This application claims priority from United Kingdom patent application number 1106999.4, filed Apr. 26, 2011; United Kingdom patent application number 1107002.6, filed Apr. 26, 2011; and United Kingdom patent application number 1106998.6, filed Apr. 26, 2011, the entire disclosures of which are incorporated herein by reference in their entirety.

### BACKGROUND OF THE INVENTION

1. Field of the Invention

The present invention relates to an audio playback apparatus and a method of playing audio from an electronic device.

2. Description of the Related Art

Advantages of using soft digital audio recording techniques are well documented and this approach has recently displaced the use of media such as tape for the recording and playback of audio materials. Thus, there are now very few advantages to recording material on cassette tape compared to using computers and solid state devices etc. However, an advantage of cassette tape is that it is very simple, tactile and easy to use in situations requiring sight-free communication, such as for the sight impaired or in situations where there are other environmental factors. Thus, an operative may be obliged to work in dark conditions and required to receive audio instruction or alternatively, such as in a combat situation, an operative may be required to receive audio instruction quickly while at the same time managing many other critical activities.

### BRIEF SUMMARY OF THE INVENTION

According to a first aspect of the present invention, there is provided a method of providing input data to an electronic device, comprising the steps of: generating a plurality of entity audio signals representing respective entity audio sources indicative of a selectable entity; and mixing said entity audio signals to produce a left channel audio output signal and a right channel audio signal, such that when played to a user said entity audio sources are perceived as being mutually displaced in an audio field. The method further comprises the steps of receiving positional data from a data input device and using this to receive an indication of the selectable entity being selected, wherein the device defines a surface that is substantially concave.

In an embodiment, the method further comprises the step of adjusting the mixing in response to the positional data so as to relocate the perceived position of an entity audio source within the audio field.

According to a third aspect of the present invention, there is provided a data input apparatus, having a generator for generating a plurality of entity audio signals representing respective entity audio sources indicative of a selectable entity. A mixer is provided for mixing the entity audio signals to produce a left channel audio output signal and a right channel audio output signal, such that when played to a user the entity audio sources are perceived as being mutually displaced in an audio field. In addition, there is provided a manually responsive input device configured to supply positional data from a user and produce an indication of an entity being selected, wherein the input device defines a surface that is substantially concave.

In an embodiment, the mixer is configured to mix the entity audio signals into a three dimensional soundscape.

According to a third aspect of the present invention, there is provided an audio playback apparatus, comprising a receiver for receiving audio data files, a storage device for storing a plurality of audio data files and a manually accessible physical play button. The apparatus is responsive to a request to sequentially play the audio data files continuously in a temporal order. The audio playback apparatus is contained within a bowl-shaped touch tablet.

### BRIEF DESCRIPTION OF THE DRAWINGS

FIG. 1 shows a multifunctional device;

FIG. 2 shows a user interface of the device identified in FIG. 1;

FIG. 3 shows a cross-section of the device detailed in FIG. 2;

FIG. 4 illustrates the construction of a circuit board;

FIG. 5 shows the cutting of the circuit board identified in FIG. 4;

FIG. 6 shows the folding of the circuit board identified in FIG. 5;

FIG. 7 shows a sound scape created by the multifunctional device shown in FIG. 1;

FIG. 8 illustrates an interaction with the sound scape;

FIG. 9 illustrates the creation of a three-dimensional sound scape;

FIG. 10 illustrates an interaction with the sound scape illustrated in FIG. 9;

FIG. 11 shows a schematic representation of data input apparatus;

FIG. 12 shows a method of providing input data;

FIG. 13 illustrates operation off the multifunctional device shown in FIG. 1 as an audio playback device;

FIG. 14 illustrates a storage track;

FIG. 15 illustrates operation of the device shown in FIG. 13;

FIG. 16 illustrates a data table;

FIG. 17 illustrates the inclusion of additional buttons in the multifunctional device; and

FIG. 18 illustrates a method of operation.

### DETAILED DESCRIPTION OF EXAMPLE EMBODIMENTS

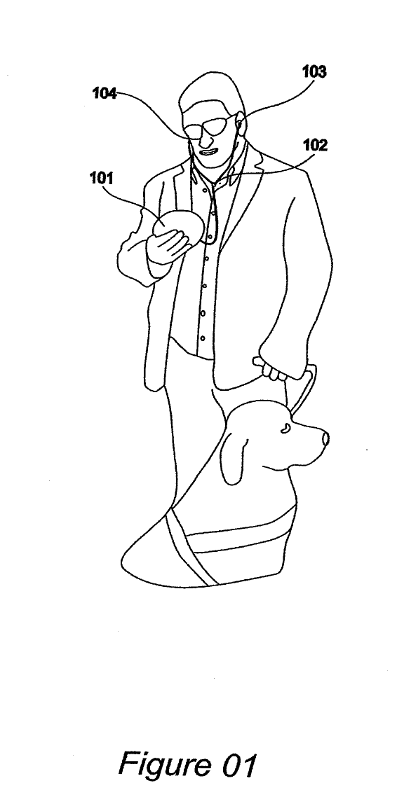

### FIG. 1

A multifunctional device 101 is shown in FIG. 1 that includes an audio output socket into which headphones 102 are connected, thereby providing audio signals to a left earpiece 103 and to a right earpiece 104.

The multifunctional device provides audio data for non-visual activities. In an embodiment, the device is suitable for enhancing the activities of the visually impaired. In an alternative embodiment, the device could be used in non-visual environments.

The multifunctional device 101 may be deployed as a user interface apparatus for an electronic device, receptive to the movement of an item over a surface in order to identify a location. In this respect the device is substantially similar to conventional touch pads. However, in order to facilitate operation within non-visual environments, the surface used to identify a location is substantially concave or bowl-shaped.

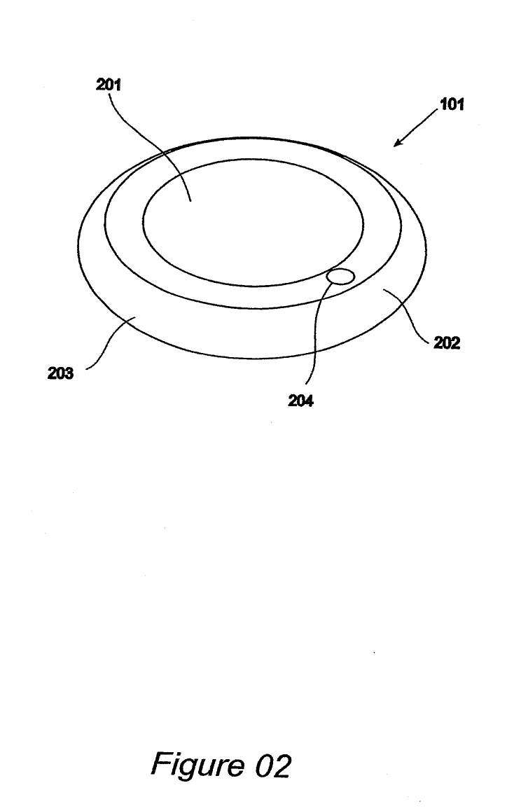

### FIG. 2

The user interface attributes of the multifunctional device 101 are detailed in FIG. 2. A substantially concave surface 201 may be optimised for being receptive to the movement of a finger over the surface. In this embodiment, the multifunctional device 101 includes a bowl-like moulding 202 defining a concave surface internally and a convex curved surface 203 externally.

In this example, the device includes a single mechanically operable button 204, possibly operable by an operator's thumb. In this way, it is possible to make use of the many attributes of the multifunctional device 101 with the device held in one hand; operatives often being required to deal with other matters with their free hand in a visually restricted environment. Thus, as illustrated in FIG. 1, it is possible for the device to be used while at the same time controlling and taking assistance from a guide dog.

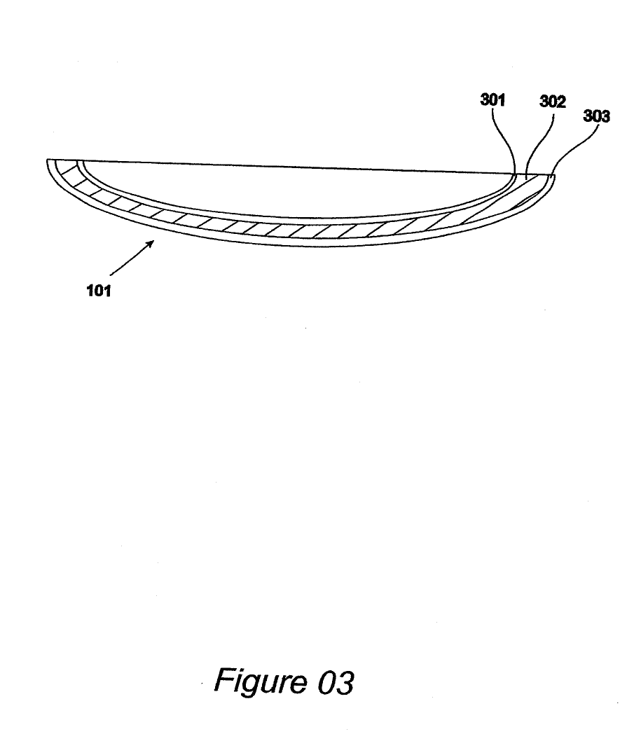

### FIG. 3

A cross section of the device 101 is illustrated in FIG. 3. In this example, an internal bowl-like moulding 301 is moulded from a dielectric plastics material 301. In an embodiment, the device is receptive to movement by capacitive sensing.

In the example of FIG. 3, capacitive sensing is implemented by an insulating substrate 302 that has a plurality of conducting regions thereon. The insulating substrates may take the form of a board, usually referred to as a printed circuit board, such that the insulating regions around the conducting regions may be defined by an etching process.

In the example of FIG. 3, the insulating substrate 302 is positioned on an outer convex surface of the bowl-shaped moulding 301, thereby encasing the conducting regions. Furthermore, it is preferable to achieve a close fit between the substrate and the bowl-shape moulding so as to avoid the presence of air gaps that could undermine the capacitive sensing capabilities of the device. An outer bowl-shaped casing 303 is provided, which may encapsulate the device as illustrated in FIG. 2.

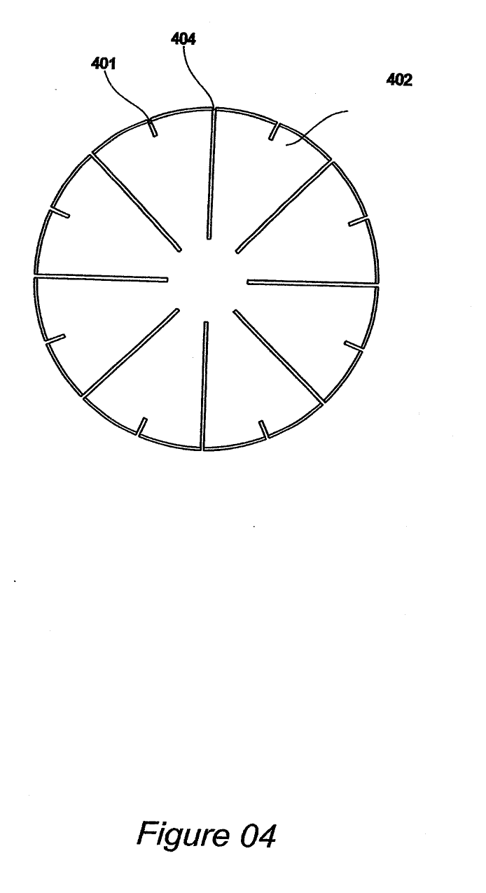

### FIG. 4

The insulating substrate 302 may initially have a two-dimensional shape 402. Thus, in this example, a substantially circular substrate is formed, possibly with further indications 403 and 404 to facilitate further adaptation.

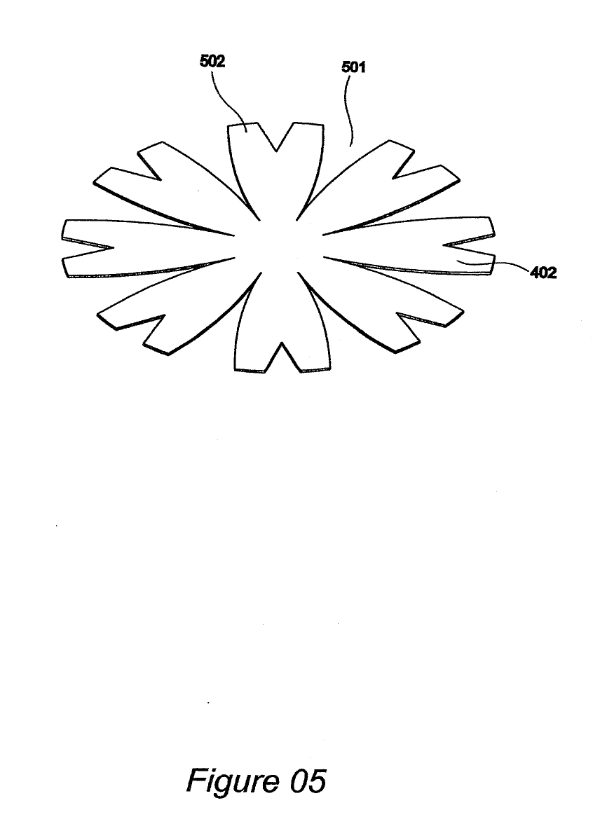

### FIG. 5

The two-dimensional circular substrate (of FIG. 4) is engineered further so as to define cut-out regions, consisting of larger cut out regions 501 and smaller cut out regions 502.

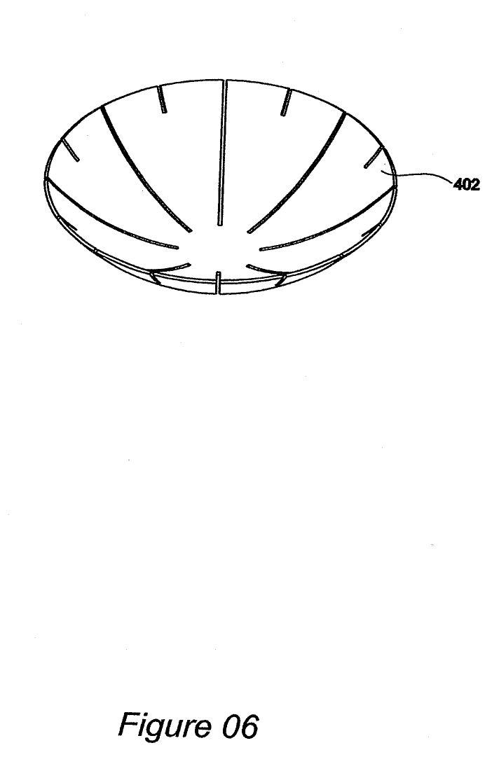

### FIG. 6

The presence of cut out regions 501 facilitate the folding of the insulating substrate 402 into a bowl-shaped substrate, as illustrated in FIG. 6. Thus, in this way, it is possible for the inner surface of the bowl-shaped substrate 302 and the outer surface of the bowl-shaped moulding 301 to have cooperating profiles.

It can therefore be seen that the multifunctional device described with reference to FIGS. 1 to 6 provides a method of interfacing electronic devices in which an item, such as a finger, is moved over a surface in order to identify a location, wherein the surface is substantially concave.

In the example described with reference to FIGS. 4, 5 and 6, a substantially circular substrate has received eight radial cuts to define eight separate segments which come together thereby defining the concave shape. In alternative embodiments, different numbers of cuts are possible and in an extreme example it would be possible to achieve a substantially concave shape with a single cut. Thus, a segment is removed and the remaining edges joined together thereby defining a substantially conical shape.

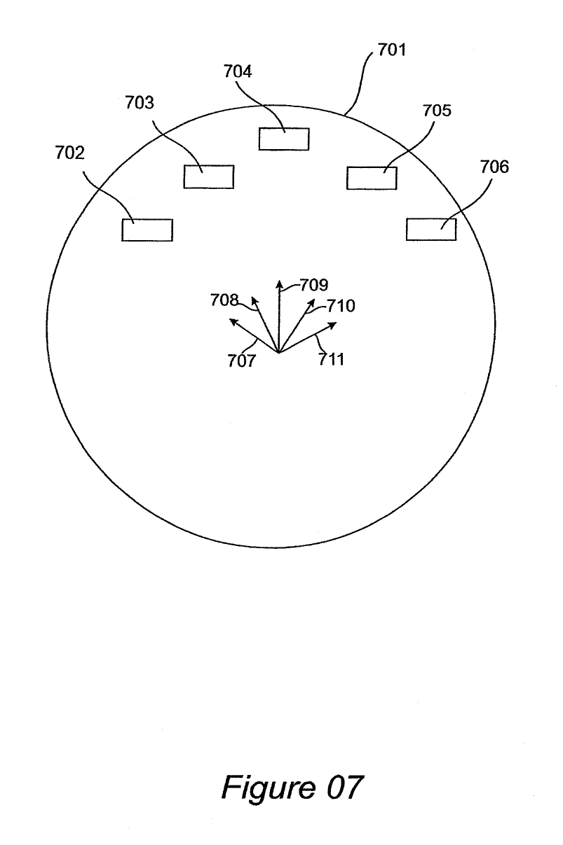

### FIG. 7

The multifunctional device 101 facilitates the deployment of a method for providing input data to an electronic device. In particular, it facilitates the use of a touch pad mechanism to achieve sight-free communication. In an embodiment, as an alternative to moving a visual curser, modifications are made to sound signals supplied to ear pieces 103 and 104.

A sound scape is illustrated in FIG. 7 in which entities are perceived as generating a sound but these sounds are in effect being synthesised by the multi-functional device. A periphery 701 is illustrated in FIG. 7 having a geometry similar to the interface surface 201 but not actually representing a direct mapping of the periphery of the physical interface. The periphery 701 is shown to illustrate attributes of the embodiment in order to present, in visual form, what is actually an aural experience.

A plurality of entity audio signals are generated representing respective entity audio sources 702 to 706. Each of these audio sources is indicative of a selectable entity. Thus, each source generates an audio sound that is meaningful in terms of the entity that it represents, which may be considered as an audio metaphor or an audio proxy.

The entity audio signals are mixed to produce a left channel audio output signal and a right channel audio output signal, such that when played to a user or operative, the entity audio sources are perceived as being mutually displaced in the audio field or soundscape. Thus, in the example of FIG. 7, a stereo mix is produced such that entity 202 appears from the user's perspective to be located in the direction of arrow 707. Similarly entity 703 is located in the direction of arrow 708, entity 704 is identified as being in the direction of arrow 709 (i.e. central) with entity 705 being in the direction of arrow 710 and arrow 711 pointing to the direction of entity 706, in the far right field.

In this way, it is possible for the individual sound sources to be identified and associated with a geometric position. As a result of this, it is possible for a geometric indication to be made such that a specific entity may be selected. Thus, by a physical movement of a finger for example it is possible for an indication to be received of a particular selectable entity (702 to 706) resulting in that particular entity being selected.

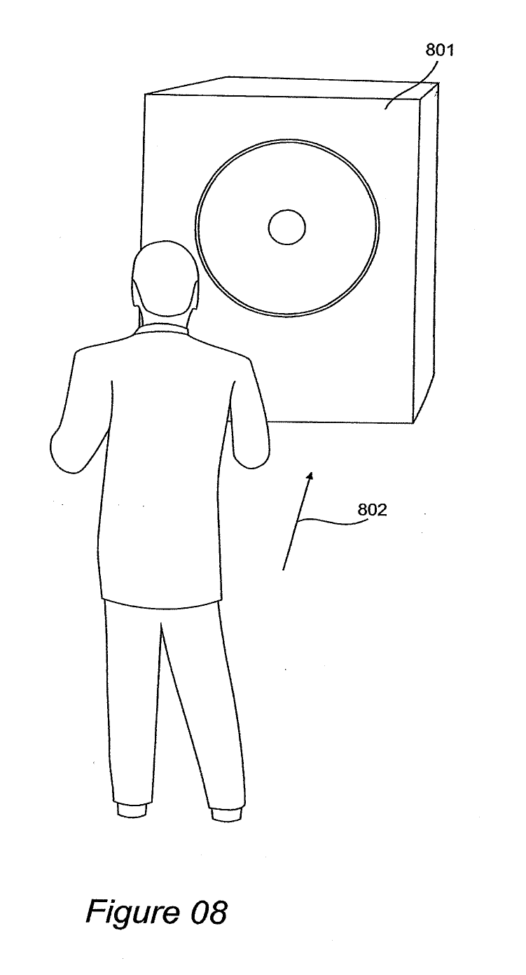

### FIG. 8

In an example, the mixing of the audio sources may be adjusted in response to receiving positional data so as to relocate the perceived position of an entity audio source within the audio field. Such an approach is illustrated in FIG. 8. Loudspeaker system 801 represents entity 704. As a finger is moved in the direction of arrow 709, a perception is made to the effect that loudspeaker 801 is coming closer towards the user or, alternatively the user feels as if they are moving in the direction of arrow 802 closer towards the loudspeaker which may also be perceived as getting bigger, i.e. louder, as the user approaches it.

The effect of remixing the audio sources in response to a movement of a finger over the interface surface may be enhanced by reducing the volume contribution from the other sources 702, 703, 705 and 706. Thus, as the volume contribution from source 704 gets louder, during a movement in the direction of arrow 709, the volume contribution from the other sources reduces. Furthermore, in an embodiment, a greater reduction could occur from sources 702 and 706, compared to sources 703 and 705 when traversing in the direction of arrow 709. Similarly, if a user were to traverse in the direction of arrow 707, source 702 would get louder and source 706 would get significantly weaker.

Having moved a finger in the direction of arrow 709, an indication may be made by a user, possibly by depressing button 204, to the effect that entity 704 is to be selected. Upon making this-selection, an audio sub menu may be generated wherein having selected the first selectable entity (704) a substantially similar sub menu of audio sources may be played to the user. It can also be appreciated that having provided the functionality of sub menus, further levels of structure may be selected by the generation of sub menus, such that having selected a sub sub-menu selectable entity, sub menu audio sources may be played to the user. Thus, in this way, it is possible for the audio interface to achieve a “drilling down” operation in a manner similar to that achievable within graphical user-interfaces.

In an embodiment, the entity audio sources may represent respective units of pre-recorded audio. Thus, the interface itself may be used to navigate audio sources of material. Each entity audio source could announce the title of the respective unit of pre-recorded audio. Alternatively, each audio source could be derived as a clip from its respective unit of pre-recorded audio.

The units of pre-recorded audio could be audio books, audio newspapers, articles within an audio newspaper, instructions, descriptions of parts of a building or environment or even a utility communication such as a phone bill. Thus, in an embodiment, a first level menu could identify several of these possibilities. Thus, entity 702 could represent books, entity 703 could represent newspapers, entity 704 could represent tours or instructions relating to buildings and galleries etc. Thus, the pre-recorded audio could be similar to that used for audio guided tours, usually where the visitor is sighted, or could be specifically produced for the sight impaired either for use in the building or as a guide for use prior to visiting the building; such that it is possible to obtain a feel for the geometry and layout of the various resources.

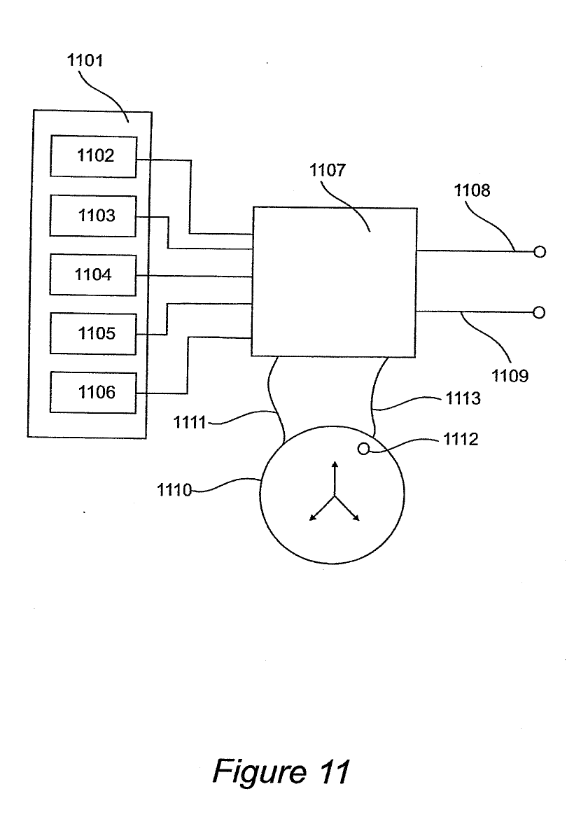

In this example, audio source 705 could relate to stored radio programs or audio material streamed to the device specifically such that, as described with reference to FIGS. 11 to 16, this material is also easily replayed via the readily accessible interface.

Audio source 706 has been identified as a region for utility communications. Thus, using this mechanism, utility bills, for energy and telecommunications for example, could be provided in audio format. In an embodiment, a format has been developed in which each audio invoice may be heard in one of three states. The first state provides an audio message to the effect that the last bill has been paid, possibly identifying the date, and that currently that nothing is outstanding. The second state could identify the fact that a bill has been despatched and that payment is expected by a certain date in the future. A third state could identify a position to the effect that an invoice has been despatched and is now overdue, possibly identifying the consequences of not attending to payment within a specified time frame. It is also envisaged that this could become a preferred means of sight-free communication to the extent that, in some jurisdictions, it may be possible for a recipient to insist on receiving utility communications in this format.

An audio source could be identified relating to the delivery of fast-food. Thus, on selecting this entity, a sub menu could be provided representing specific fast-food outlets. Sounds associated with these outlets could be generated, possibly including corporate jingles or sounds that have been selected by a user during a configuration process.

In an alternative example, the units of pre-recorded audio are elements contained within a website. The interface described herein facilitates the adoption of what may be referred to as an audio browser. An audio website may be created specifically for use within this environment. Alternatively, in some embodiments, it would be possible to examine existing text-based websites and perform a text-to-speech operation while retaining aspects of the structure of the website. Thus, using the audio control described herein, it is possible to navigate within the structure of the website. Thus, in an embodiment, for each web page or unit within the website, a selectable entity is identified for which an entity audio signal is created. These entity audio signals are then displaced in three-dimensional space, as identified in FIG. 7 and are initially heard in combination. As the interface is used to effect movement as previously described, an entity audio signal would become louder, displacing the other sources into the background, such that an appropriate selection could be made.

The embodiment described with respect to FIGS. 7 and 8 mixes the entity audio sources into a stereo field such that the position effectively sweeps in an arc or plane from a left extreme to a right extreme.

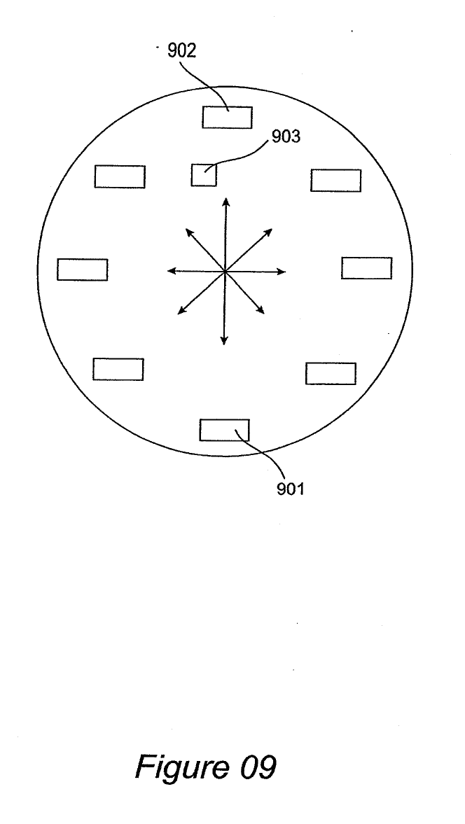

### FIG. 9

In an alternative example, as illustrated in FIG. 9, it is possible to create the illusion of the entities being present within a true three-dimensional soundscape. A three-dimensional audio processor is present, possibly involving convulsion techniques that make reference to three-dimensional data derived empirically. Using these techniques, it is possible for entity 901 to be perceived as generating audio at a location behind the operative, compared to entity 902 which is perceived as generating audio in front of the operative. Furthermore, it is possible to create an illusion to the effect that an entity, such as entity 903, is generating sound that is actually closer to the user, compared to entity 902 which is perceived as being further away. Thus, in addition to creating a left to right field (as in conventional stereo) it is also possible to create the illusion of depth which again may be deployed in order to refine the selection process.

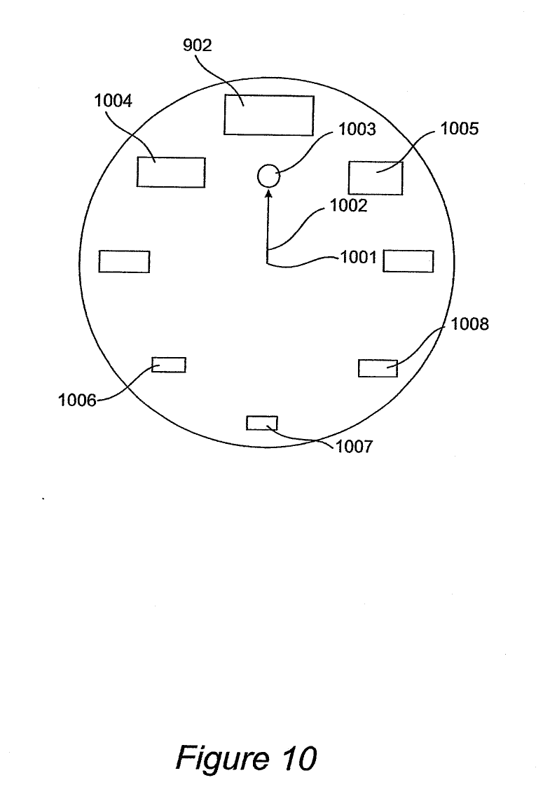

### FIG. 10

The soundscape of FIG. 9 is also illustrated in FIG. 10, in which a finger has been placed on the touch pad so as to identify location 1001 in the soundscape. The finger is then moved in the direction of arrow 1002 so as to be then held at a position 1003. This results in sound source 902 becoming louder, illustrated as a larger icon in FIG. 10. Similarly, sound source 1004 becomes slightly louder and sound source 1005 also becomes slightly louder. Sound sources 1006, 1007 and 1008 become quieter.

### FIG. 11

A schematic representation of the data input apparatus is illustrated in FIG. 11. A generator 1101 generates entity audio signals representing respective entity audio sources 1102 to 1106 indicative of a selectable entity. A mixer 1107 mixes the entity audio signals to produce a left channel audio output signal 1108 and a right channel audio output signal 1109. In this way, when the output audio signals are played to a user, the entity audio sources are perceived as being mutually displaced in an audio field, as shown in FIG. 7.

A manually responsive input device 1110 is configured to supply positional data 1111 from a user and an indication (via button 1112 and over interface 1113) of an entity being selected. Preferably, the mixer is adjusted in response to the positional data so as to relocate the perceived position of entities within an audio field. This may create the illusion of moving closer to a selectable entity. In an embodiment, the mixer is configured to mix the entity audio signals to create a stereo field. Alternatively, the mixer may be configured to mix the entity audio signals into a three-dimensional sound scape.

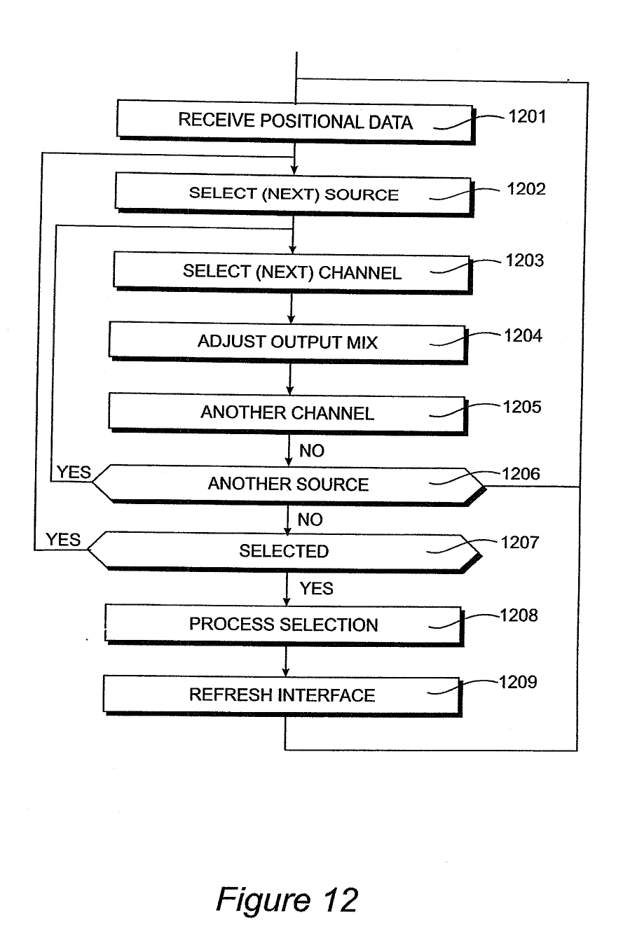

### FIG. 12

A method of providing input data to an electronic device is effected within the mixer 1107, performing procedures identified in FIG. 12.

At step 1201 positional data is received (from device 1110 over interface 1111) effectively identifying the location within the sound scape.

At step 1202 a source is selected which, on the first iteration, may be source 1102.

A mono output may be produced in which the volume of audio input sources may be mixed into the single mono output. In a preferred embodiment, a stereo mix is produced and an output is provided to a left channel and to a right channel. In alternative systems, more than two output signals may be generated, such as in a surround sound configuration.

At step 1203 a channel is selected which may be the left channel for the purposes of this example. Based on the position data received at step 1201, the output mix for this particular component of the selected channel is adjusted at step 1204.

At step 1205 a question is asked as to whether another channel is available and when answered in the affirmative, the next channel is selected at step 1203. Thus, having selected the left channel for source 1102, on this iteration the right channel for source 1102 will be selected. An output mix will be generated for this component of the channel and at step 1205 a question will be asked as to whether another channel is to be considered. For the purposes of this example, when answered in the negative, a question is asked at step 1206 as to whether another source is to be considered. Again, for the purposes of this example, when answered in the affirmative the next source (source 1103) is selected at step 1202.

Eventually, all channels (two in this example) for all of the audio sources (five in this example) will have been considered and a question is then asked at step 1207 as to whether the position has been selected. In this example, a selection is made by the manual operation of button 1112 and when answered in the affirmative, the selection is processed at step 1208. Thus, the processing of this selection may result in a particular action taking place, possibly an audio file being played or a submenu being presented. In any event, the interface is refreshed at step 1209 such that the system is in a position to receive further positional data at step 1201.

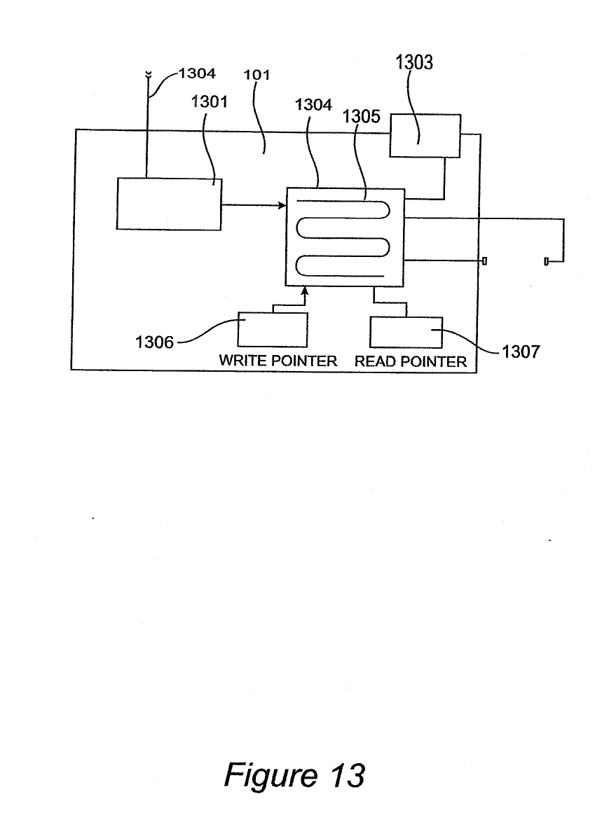

### FIG. 13

In an alternative mode of operation, the multifunctional device 101 may operate as a simple playback device emulating, as far as possible, the functionality of a standard cassette player. The multifunctional device 101 includes a receiver 1301 for receiving audio data files. A storage device 1302 is also included for storing audio data files received by the receiver 1301. A manually accessible play button 1303 is responsive to a request to sequentially play the audio data files contiguously in a temporal order.

In an embodiment, the data files may be transmitted over the Internet and are received in packets via a physical medium or via a radio link 1304. In an embodiment, the audio data files are in a compressed digital format, such as an MP3 or WAV file format.

In the embodiment of FIG. 13, the storage device 1302 is a solid state storage device, although other types of storage may be deployed, such as a magnetic disc.

Track 1305 within the storage device 1302 represents the sequential nature in which the files are written to storage and then read from storage in a first-in-first-out configuration. Thus, logically, the files are stored in a sequential linear order, preferably representing the time at which they arrived, such that when new data arrives, it is written to storage 1302 in a sequential order under the control of an incrementing record or write pointer 1306. Similarly, when data is read from storage, the reading operation is performed in response to an incrementing replay or read pointer 1307.

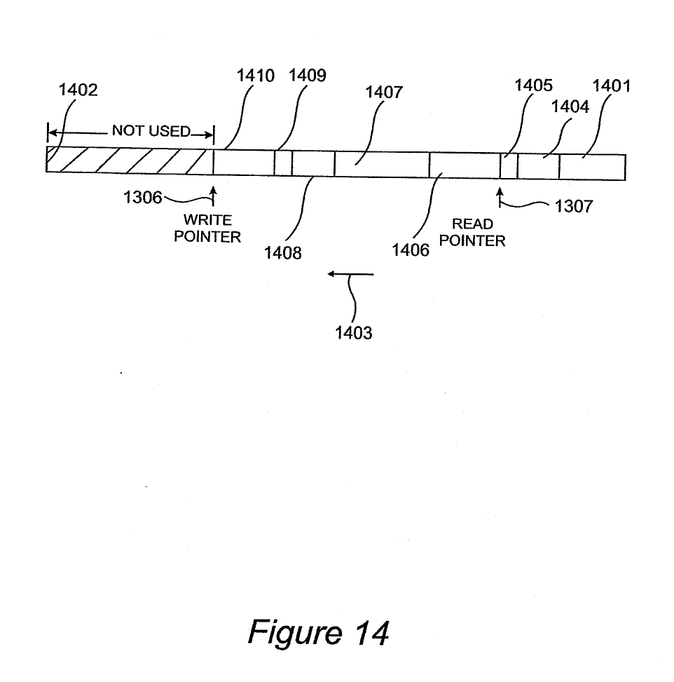

### FIG. 14

Storage track 1305 is illustrated in FIG. 14. Track 1305 starts at memory location 1401 and progresses to memory location 1402. Thus, the writing and reading of data effectively progresses in the direction of arrow 1403.

In this example, data file 1404 was the first to be written to storage, followed by data file 1405, data file 1406, data file 1407, data file 1408, data file 1409 and finally data file 1410. Storage region 1411 also exists but for the purposes of this example, no data has been written to these storage locations.

The right pointer 1306 will continue to be incremented in the direction of arrow 1403 up to the final memory location at 1402. In this example, the position of the read pointer 1307 indicates that files 1404 and 1405 have been read, i.e. played back. In an embodiment, having been played once, it is assumed that they will not be required again therefore they are overwritten on the next right cycle.

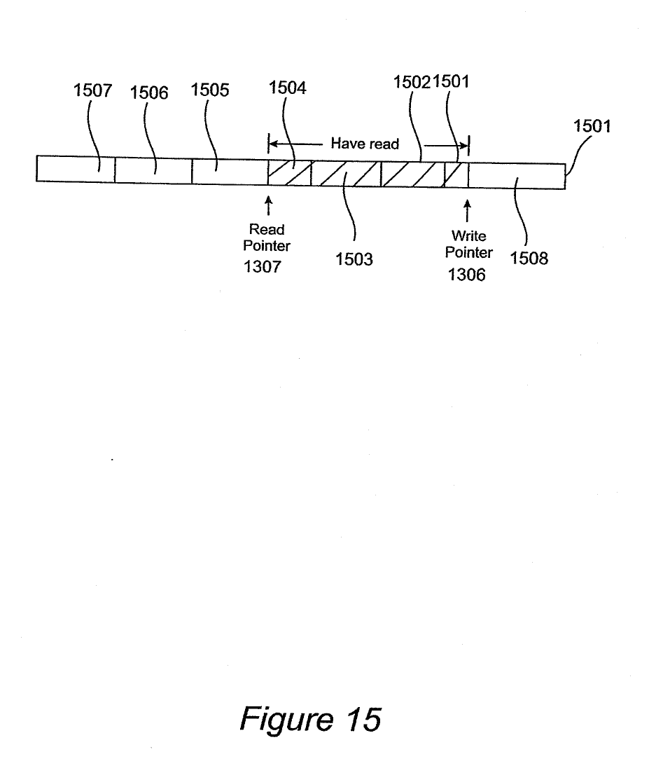

### FIG. 15

In the example shown in FIG. 15, read pointer 1307 has advanced such that files 1501, 1502, 1503 and 1504 have been read. Files 1505, 1506 and 1507 have been recorded but as yet they have not been played back. Having recorded file 1507 the right pointer was returned to location 1401 and new files were recorded at location 1508. Thus, given the position of right pointer 1306, the next recording operation would erase file 1501. The next reading or replaying operation will play file 1505.

Thus, in an embodiment, audio data files remain in storage until all of the available memory has been used, whereafter the audio data files are overwritten with new material on a first-in-first-out basis.

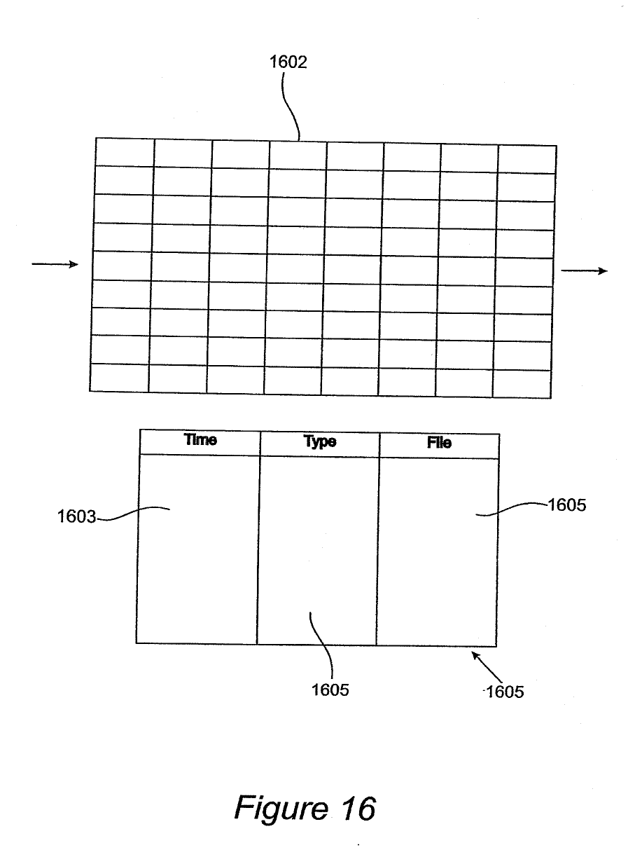

### FIG. 16

In an alternative embodiment, a data table 1601 is included such that each audio file includes a temporal designation. Details of these designations are maintained in the table such that the data files are read from storage in an order determined by these temporal designations. Thus, as data arrives, the files or segments of files (packets) are written randomly to a randomly addressable storage apparatus 1602.

The data table includes a column 1603 for recording the time of the audio data file, effectively representing an indicated time for the replaying of the audio data file, not necessarily the date on which the file was sent.

A column 1604 allows data to be stored representing the type of file. In particular, this may indicate that a data file has minimal temporal relevance, meaning that it will still be relevant in say one week's time. Alternatively, a designation could be given to the effect that the file is highly temporally relevant and should be played as soon as possible. This may for example represent breaking news items which could effectively become very stale within a matter of hours. A third column 1605 represents an indication of the location of the file within the storage apparatus 1602.

In an embodiment, a single operation of say button 204 when operating in this mode may result in the audio data being replayed from the position of the read pointer 1307 or from an identification of the earliest time designation read from column 1603. A further press of button 204 stops the replaying of audio in a toggle-like fashion.

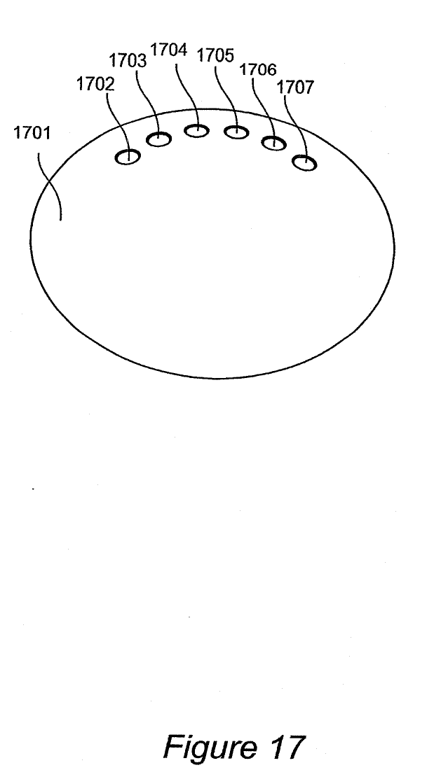

### FIG. 17

In an alternative embodiment, the underside 1701 of the multifunctional device 101 may include additional buttons. Furthermore, in an embodiment, it may be possible for the device to record audio locally in addition to receiving audio. The recorded audio may be stored in a different way and retrieved in a different way or, in an embodiment, the audio material recorded locally is handled in the same way as remotely received audio material. Thus, to facilitate the recording and playback of audio material a first button 1702 may select the record feature with a second button 1703 selecting the playback feature. A third button 1704 may select a rewind operation with a fourth button 1705 selecting a fast forward operation. Button 1706 may represent a hard stop which could return the device to an alternative mode or base mode of operation. The operation of a sixth button 1707 may effect a pause operation with a further depression of this button returning the device to its playback mode. In this way, buttons 1702 to 1707 substantially emulate the operation of a conventional cassette recorder.

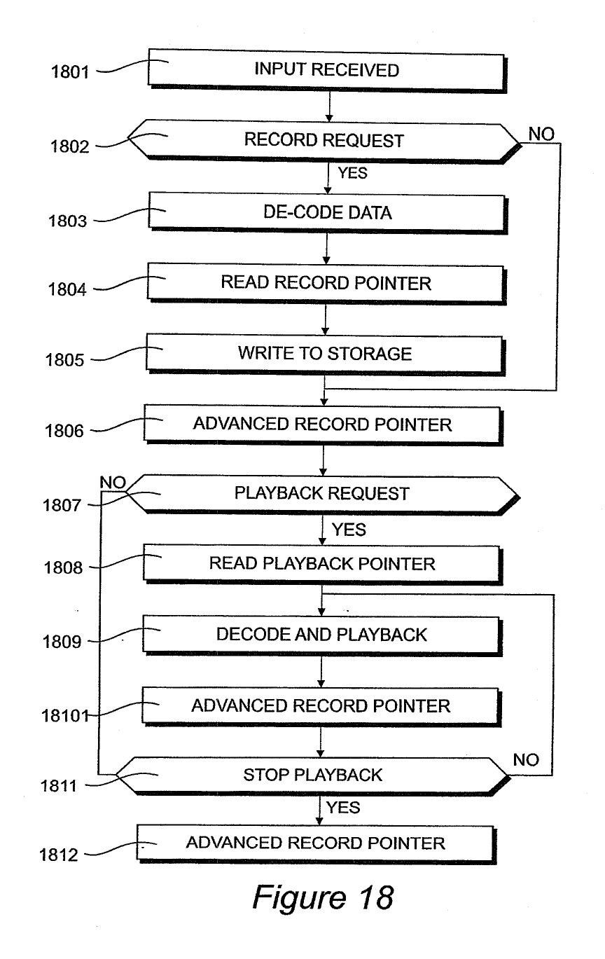

### FIG. 18

In an embodiment, programmable devices facilitate the operation of the system and the program control. Software infrastructure may be established by the inclusion of the android operating system for example or by making use of standard hardware components compatible with the software platform.

An application performed by the multifunctional device to achieve the functionality described with respect to FIGS. 13 to 17 is illustrated in FIG. 18.

The method of FIG. 18 relates to the playing of audio material from an electronic device. Audio material is received from an external source and played back locally to an operator.

At step 1801 input data is received and at step 1802 a question is asked as to whether this is a request to record data. When answered in the affirmative, the received data is decoded at step 1803 and at step 1804 the record pointer is read so as to identify the next location in memory to which the received data is to be written.

At step 1805 the data is written to storage and the record pointer is then advanced at step 1806. At step 1807 a question is asked as to whether a playback request was received which on this iteration would be answered in the negative and the system would then await the next input at step 1812.

If upon receiving an input the question asked at step 1802 is answered in the negative, to the effect that this is not a request to record, a question is asked at step 1807 as to whether a playback request has been received. Upon detecting a playback request, resulting in the question asked at step 1807 being answered in the affirmative, the playback pointer is read at step 1808. At step 1809 recorded audio is decoded and played back whereafter at step 1810 the playback pointer is advanced.

At step 1811 a question is asked as to whether the playback has been stopped and when answered in the negative, further audio is decoded and played back at step 1809. Upon receiving a request to stop the playback (or pause the playback) the question asked at step 1811 is answered in the affirmative and the next input is awaited at step 1812.

1. A method of providing input data to an electronic device, comprising the steps of:
generating a plurality of entity audio signals representing respective entity audio sources indicative of a selectable entity;
mixing said entity audio signals to produce a left channel audio output signal and a right channel audio output signal, such that when played to a user said entity audio sources are perceived as being mutually displaced in an audio field; and
receiving positional data from a data input device and using said positional data to receive an indication of said selectable entity being selected, wherein said input device defines a surface that is substantially concave.

2. The method of claim 1, further comprising the step of adjusting said mixing in response to said positional data so as to relocate the perceived position of an entity audio source within said audio field.

3. The method of claim 2, further comprising the step of adjusting said mixing in response to said positional data so as to create an illusion of moving closer to a selected entity.

4. The method of claim 1, further comprising the step of generating audio sub-menus, wherein having selected a selectable entity, sub-menu audio sources are played to a user.

5. The method of claim 4, further comprising the step of generating sub sub-menus, such that having selected a sub-menu selectable entity, sub sub-menu audio sources are played to a user.

6. The method of claim 1, wherein said entity audio sources represent respective units of pre-recorded audio.

7. The method of claim 6, wherein said units of pre-recorded audio are selected from one or more of the following, comprising; audio books, audio newspapers, articles within an audio newspaper, instructions, descriptions of parts of a building or an environment, and utility communications.

8. The method of claim 1, wherein said mixing step mixes said entity audio signals into a stereo field.

9. A data input apparatus, comprising;
a generator for generating a plurality of entity audio signals representing respective entity audio sources indicative of a selectable entity;
a mixer for mixing said entity audio signals to produce a left channel audio output signal and a right channel audio output signal, such that when played to a user said entity audio sources are perceived as being mutually displaced in an audio field; and
a manually responsive input device configured to supply positional data from a user and to convey an indication of an entity being selected, wherein said manually responsive input device defines a surface that is substantially concave.

10. The apparatus of claim 9, wherein said mixer is adjusted in response to said positional data so as to relocate the perceived position of entities within an audio field.

11. The apparatus of claim 10, wherein said mixer is adjusted in response to said positional data so as to create an illusion of moving closer to a selected entity.

12. An audio playback apparatus, comprising:
a receiver for receiving audio data files;
a storage device for storing a plurality of said audio data files; and
a manually accessible physical play button, wherein;
said apparatus is responsive to a request to sequentially play said audio files continuously in a temporal order, and said audio playback apparatus is contained within a bowl-shaped touch tablet.

13. The apparatus of claim 12, wherein said data files of said apparatus are transmitted and received in packets via a physical medium of via a radio link.

14. The apparatus of claim 12, wherein said audio data files are in a compressed digital format.

15. The apparatus of claim 12, wherein said storage device is a solid state storage device.

16. The apparatus of claim 12, wherein said audio data files remain in storage until all the available memory has been used, whereafter said audio data files are overwritten with new material on a first-in-first-out basis.

17. The apparatus of claim 12, further comprising a data table, wherein: each said audio data file includes a temporal designation and details of said designations are maintained in said table, wherein;
said audio files are read from said storage device in an order determined by said temporal designations.

18. The apparatus of claim 12, wherein a first press of said manually accessible physical play button results in the sequential playing of said audio files and a second press of said manually accessible physical play button causes the playing of said files to stop.

19. The apparatus of claim 12, including an additional stop button for stopping the sequential play of said audio data files.

20. The apparatus of claim 19, including a fast forward button and a rewind button.
